(19) United States
(12) Patent Application Publication
(10) Pub. No.: US 2008/0316251 A1
(43) Pub. Date: Dec. 25, 2008

(54) PRINT HEAD CLEANING DEVICE AND INK-JET IMAGE FORMING APPARATUS HAVING THE SAME

(75) Inventor: Gun HEO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/102,132

(22) Filed: Apr. 14, 2008

(30) Foreign Application Priority Data
Jun. 21, 2007 (KR) 2007-61067

(51) Int. Cl. B41J 2/165

(52) U.S. Cl. 347/28

(57) ABSTRACT

A print head cleaning device and an ink-jet image forming apparatus having the same are disclosed. The ink-jet image forming apparatus includes a print head having a nozzle part to eject an ink, and a print head cleaning device to clean the nozzle part. The print head cleaning device includes a cleaning liquid tank to store a cleaning liquid, a cleaning bath mounted below the nozzle part to be supplied with the cleaning liquid from the cleaning liquid tank, a connecting tube to connect the cleaning liquid tank to the cleaning bath, a pump connected to the connecting tube to circulate the cleaning liquid, a sensing tube mounted in a portion of the connecting tube and provided with a flow passage through which the cleaning liquid flows, a moving member mounted within the flow passage of the sensing tube so as to move by the flow of the cleaning liquid, and a sensor to sense the movement of the moving member. Accordingly, it can be easily ascertained whether the cleaning liquid is smoothly supplied, by sensing the movement of the moving member in the sensing tube mounted within the cleaning liquid supply passage.

### CROSS-REFERENCE TO RELATED APPLICATIONS

This application claims the benefit and the priority under 35 U.S.C. §119(a) of Korean Patent Application No. 2007-0061067, filed on Jun. 21, 2007 in the Korean Intellectual Property Office, the disclosure of which is incorporated herein by reference in its entirety.

### BACKGROUND OF THE INVENTION

1. Field of the Invention

The present general inventive concept relates to an ink-jet image forming apparatus, and more particularly to a print head cleaning device and an ink-jet image forming apparatus having the same that can remove residual ink or foreign substances from a nozzle part of a print head which ejects an ink.

2. Description of the Related Art

An image forming apparatus is an apparatus that prints a black and white image or a color image on a printing medium, e.g., paper, according to an image signal, and is, for example, a laser printer, an ink-jet printer, a copying machine, a multi-function printer, a fax machine, etc. An image forming apparatus is classified as an electrophotographic type in which a beam is scanned onto a photosensitive body to form an electrostatic latent image and a developer is supplied to the electrostatic latent image to transfer the same onto a printing medium, or an ink-jet type in which a liquid type ink is ejected onto a surface of a printing medium according to an image signal.

The ink-jet image forming apparatus is provided with a print head which ejects an ink according to an image signal. The print head is provided with a nozzle part through which an ink droplet is ejected according to the image signal to print letters or pictures on a printing medium. The print head is classified as a shuttle type print head which ejects an ink while reciprocatingly moving in a printing medium feeding direction (sub scanning direction) and in a direction perpendicular to the feeding direction (main scanning direction), or an array type print head which is provided with a nozzle part having a length corresponding to a width of a printing medium and can achieve line printing. The ink-jet image forming apparatus including the array type print head is configured such that the print head is in a fixed state and only the printing medium moves in the sub scanning direction, and accordingly it has an advantage that a structure of a driving device is simple and high speed printing can be achieved.

The shuttle type print head and the array type print head are commonly provided with nozzle parts to eject an ink. The nozzle part includes a plurality of nozzles. After the ejection of the ink, an ink drop remains on the nozzle part. However, if the print head is left for a long time such that the ink drop remains on the nozzle part, the residual ink drop on the nozzle part may become solidified due to contact with air, or foreign substances such as dust in the air may be attached to the ink drop. The solidified ink or the foreign substances prohibit the smooth ink ejection, causing the deterioration of a printing quality, and may even choke the nozzles, making the printing operation impossible.

To solve this problem, the ink-jet image forming apparatus is provided with a maintenance device to perform maintenance operations, such as spitting, wiping and capping. The spitting is to eject the ink several times at a regular interval to remove the ink whose viscosity becomes high. The wiping is to wipe off the foreign substances such as an ink drop from the nozzle part. The capping is to cap the nozzle part to shield the nozzle part from external air.

However, if the print head is used for a long period, in spite of the maintenance operations, such as the spitting, the wiping and the capping, a problem may occur that the residual ink drop on the nozzle part becomes solidified or the foreign substances are attached to the ink drop, and thus the nozzles are choked.

To solve this problem, a technique of cleaning the nozzle part of the print head using a cleaning liquid has been recently developed. A cleaning liquid is supplied into a cleaning bath mounted below the print head, and the cleaning liquid in the cleaning bath is oscillated by an ultrasonic generating device to clean the nozzle part by the waves created in the cleaning liquid. After cleaning the print head, the cleaning liquid is collected into a cleaning liquid tank, and is reused.

However, if the cleaning liquid is used for a long period of time, the cleaning liquid may run short by leaking or by evaporation. Also, if the cleaning liquid cannot be smoothly supplied into the cleaning bath, for example, due to the block of a flow passage, the ultrasonic generating device may break down or a problem in safety may occur. Also, because the cleaning liquid is collected after cleaning the print head and is reused, as a contamination level of the cleaning liquid increases, a cleaning efficiency is considerably deteriorated. Therefore, in order to secure the smooth operation of the print head cleaning device, it should be ascertained whether the cleaning liquid is smoothly supplied into the cleaning bath, before the cleaning operation is carried out. Further, the cleaning liquid should be replenished and replaced at a proper timing.

### SUMMARY OF THE INVENTION

The present general inventive concept provides a print head cleaning device and an ink-jet image forming apparatus having the same that is capable of ascertaining whether a cleaning liquid is smoothly supplied.

The present general inventive concept also provides a print head cleaning device and an ink-jet image forming apparatus having the same that is capable of detecting a contamination level of the cleaning liquid.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink-jet image forming apparatus including a print head having a nozzle part to eject an ink, and a print head cleaning device to clean the nozzle part, the print head cleaning device including a cleaning liquid tank to store a cleaning liquid, a cleaning bath mounted below the nozzle part to be supplied with the cleaning liquid from the cleaning liquid tank, a connecting tube to connect the cleaning liquid tank and the cleaning bath, a pump connected to the connecting tube to circulate the cleaning liquid, a sensing tube mounted in a portion of the connecting tube and provided with a flow passage through which the cleaning liquid flows, a moving member mounted within the flow passage of the sensing tube so as to freely move by the flow of the cleaning liquid, and a sensor to sense the movement of the moving member.

The sensing tube may further include a movement guide portion disposed within the flow passage, in which the moving member moves up by the flowing cleaning liquid and moves down by its own weight.

The sensing tube may further include a connecting portion disposed within the flow passage, which connects the movement guide portion to a portion of the connecting tube disposed in close proximity to the cleaning bath, and the movement guide portion may be provided with a shelter portion which is formed above the connecting portion. When the cleaning liquid flows, the moving member may escape into the shelter portion without blocking the flow of the cleaning fluid in the connecting portion.

The moving member may float on the cleaning liquid.

The sensing tube may be transparent, and the sensor may be configured as an optical sensor having a light emitting part and a light receiving part. The light emitting part and the light receiving part may be arranged such that the flow passage of the sensing tube is interposed therebetween.

The sensor may be capable of sensing a contamination level of the cleaning liquid flowing through the sensing tube.

The ink-jet image forming apparatus may further include a control device to control an operation of the pump in response to a sensing signal provided by the sensor.

The foregoing and/or other aspects and utilities of the present general inventive concept may also be achieved by providing a print head cleaning device comprising: a cleaning liquid tank to store a cleaning liquid, a cleaning bath supplied with the cleaning liquid from the cleaning liquid tank, a connecting tube to connect the cleaning liquid tank to the cleaning bath; a pump connected to the connecting tube to circulate the cleaning liquid, a sensing tube mounted in a portion of the connecting tube and provided with a flow passage through which the cleaning liquid flows, a moving member mounted within the flow passage of the sensing tube so as to move by the flow of the cleaning liquid, and a sensor to sense the movement of the moving member.

The sensing tube may be provided with a movement guide portion in the flow passage, in which the moving member moves up by the flowing cleaning liquid and moves down by its own weight.

The sensing tube may be provided with a connecting portion in the flow passage, which connects the movement guide portion and a portion of the connecting tube disposed in close proximity to the cleaning bath, and the movement guide portion is provided with a shelter portion which is formed above the connecting portion, whereby when the cleaning liquid flows, the moving member escapes into the shelter portion without blocking the flow of cleaning fluid in the connecting portion.

The foregoing and/or other aspects and utilities of the present general inventive concept may also be achieved by providing a print head cleaning device, including a cleaning liquid tank to store a cleaning liquid, a cleaning bath to clean the print head, a pump to circulate the cleaning liquid between the cleaning liquid tank and the cleaning bath, and a connecting tube to connect the cleaning liquid tank, the pump and the cleaning bath to flow the cleaning liquid therein, the connecting tube including a sensing unit mounted therein to sense the opacity of the cleaning liquid in the connecting tube.

The sensing unit may include a tube coupling part to connect to the connecting tube, and a flow passage connected to the tube coupling part and having a sensor disposed thereon to sense the opacity of the cleaning liquid flowing within the flow passage.

A circulation operation of the pump may cease when the sensed opacity of the cleaning liquid is greater than a predetermined level.

The foregoing and/or other aspects and utilities of the present general inventive concept may also be achieved by providing a method to control a cleaning operation of a print head, the method including operating a pump to cause the cleaning fluid to flow in a first direction between a cleaning liquid tank and a cleaning bath, sensing a level change of a sensing signal provided by a sensor which senses a position of a moving member in the flow of the cleaning fluid, determining whether an adequate amount of cleaning fluid is present in the cleaning bath according to the sensed level change of the sensing signal, stopping the pump when the adequate amount of cleaning fluid is present; and operating an ultrasonic generating device to clean a plurality of nozzles disposed on the print head.

The method may further include operating the pump to cause the cleaning fluid to flow in a second direction between the cleaning liquid tank and the cleaning bath.

The method may further include stopping the pump operation when an inadequate amount of cleaning fluid is sensed according to the sensing of the level change of the sensing signal.

The method may further include sensing a contamination level of the cleaning fluid flowing between a cleaning liquid tank and a cleaning bath.

The method may further include providing an error message to a display when the sensed contamination level is greater than a predetermined level.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a perspective view schematically illustrating an ink-jet image forming apparatus in accordance with an exemplary embodiment of the present general inventive concept;

FIG. 2 is a block diagram illustrating a partial arrangement of the ink-jet image forming apparatus in accordance with an exemplary embodiment of the present general inventive concept;

FIG. 3 is a side view illustrating a print head cleaning operation of the ink-jet image forming apparatus in accordance with an exemplary embodiment of the present general inventive concept;

FIG. 4 is a perspective view schematically illustrating a printing head cleaning device of the ink-jet image forming apparatus in accordance with an exemplary embodiment of the present general inventive concept;

FIG. 5 is an enlarged view illustrating a sensing tube and a sensor of the print head cleaning device illustrated in FIG. 4;

FIGS. 6A-6C are side-sectional views illustrating an operation of the sensing tube and the sensor illustrated in FIG. 5;

FIG. 7 is a graph illustrating a change of a sensing signal provided from the sensor illustrated in FIGS. 6A-6C; and

FIG. 8 is a graph illustrating a change of an intensity of the sensing signal provided from the sensor illustrated in FIGS. 6A-6C over time.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

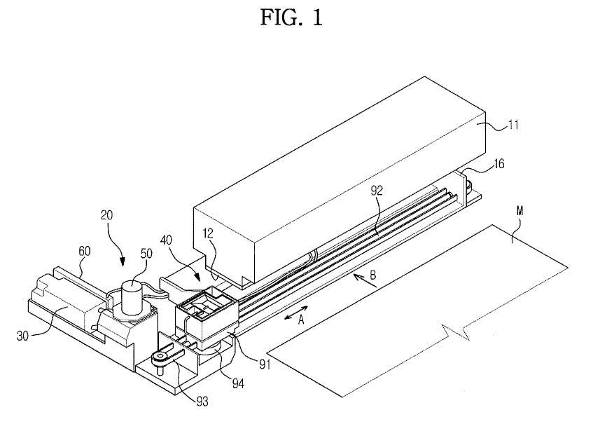

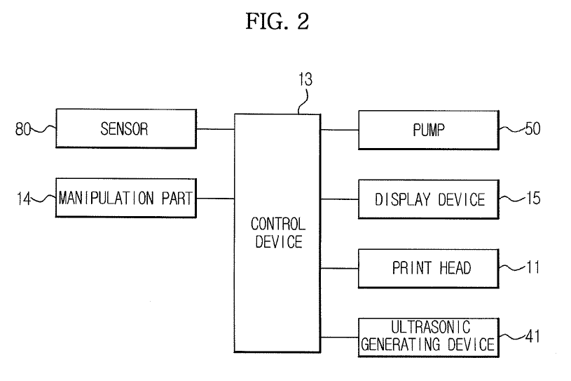

FIG. 1 is a perspective view schematically illustrating an ink-jet image forming apparatus in accordance with an exemplary embodiment of the present general inventive concept, and FIG. 2 is a block diagram illustrating a partial arrangement of the ink-jet image forming apparatus in accordance with an exemplary embodiment of the present general inventive concept.

An ink-jet image forming apparatus according to an exemplary embodiment of the present general inventive concept is an array type ink-jet image forming apparatus in which a print head has a length corresponding to a width of a printing medium M to achieve line printing. As illustrated in FIGS. 1 and 2, the ink-jet image forming apparatus includes a print head 11 to eject an ink onto a printing medium, a print head cleaning device 20 to clean the print head 11, a control device 13 to control an overall operation of the array type ink-jet image forming apparatus, a manipulation part 14 (which may be, for example, function buttons) to enable a user to operate the apparatus, and a display device 15 (which may be a touchscreen display) to inform a user of information of a printing condition or an operational error. Although not illustrated in the drawings, the ink-jet image forming apparatus of the present general inventive concept may further include a main body having a printing medium supply unit and a printing medium discharge unit, and a plurality of rollers to feed a printing medium M. The ink-jet image forming apparatus may also include an ultrasonic generating device 41, a pump 50 and a sensor 80, which are described below in greater detail.

The print head 11 may include a nozzle part 12 to eject the ink, and the nozzle part 12 includes a plurality of nozzles (not illustrated) which are directed downward toward the printing medium M. When the printing medium M passes below the print head 11, the print head 11 ejects the ink through the nozzle part 12 onto the surface of the printing medium M to print letters or pictures. The ink ejecting operation of the print head 11 is controlled by the control device 13.

Referring to FIGS. 1, 3 and 4, the print head cleaning device 20 may include a cleaning liquid tank 30 to store a cleaning liquid, a cleaning bath 40 mounted below the print head 11 to clean the nozzle part 12, plural connecting tubes 21, 22, 23, 24 and 25 to connect the cleaning liquid tank 30 to the cleaning bath 40 so that the cleaning liquid can circulate between the cleaning liquid tank 30 and the cleaning bath 40, a pump 50 mounted between the cleaning liquid tank 30 and the cleaning bath 40 to circulate the cleaning liquid, an auxiliary tank 60 mounted between the cleaning liquid tank 30 and the cleaning bath 40 to temporarily store the cleaning liquid, a sensing tube 70 mounted in a portion, for example a middle portion, of at least one of the plural connecting tubes 21, 22, 23, 24 and 25 so as to sense the circulation of the cleaning liquid, and a sensor 80 to sense the flow of the cleaning liquid passing through the sensing tube 70. The sensor 80 may be disposed within the sensing tube 70, or immediately adjacent to the sensing tube 70 within the respective connecting tube 21-25 where the sensing tube 70 is mounted.

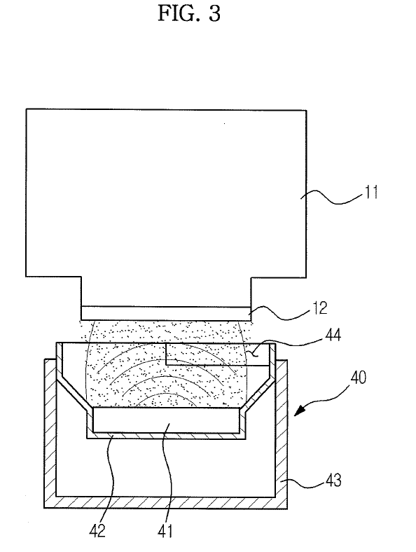

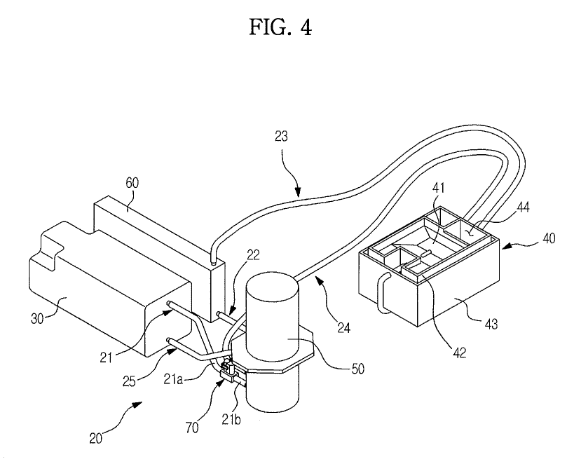

As illustrated in FIGS. 3 and 4, when the pump 50 operates, the cleaning liquid stored in the cleaning liquid tank 30 flows into the pump 50 through the first connecting tube 21, flows into the auxiliary tank 60 from the pump 50 through the second connecting tube 22, and is supplied into the cleaning bath 40 from the auxiliary tank 60 through the third connecting tube 23.

Referring to FIG. 1, the cleaning bath 40 is loaded on a carriage 91 slidably mounted on a frame 16 of the ink-jet image forming apparatus so as to clean the nozzle part 12 of the print head 11 while moving in a main scanning direction A. As illustrated in FIG. 1, the carriage 91 is slidably mounted on a guide shaft 92 which extends along in a transversal direction in the frame 16. The frame 16 may be further mounted with a driving belt 93 and a driving motor 94 to move the carriage 91. The driving belt 93 can turned by the driving motor 94 which rotates in forward and reverse directions, and the carriage 91 may be coupled to a portion of the driving belt 93. Accordingly, when the driving motor 94 operates, the driving belt 93 is turned, and the carriage 91 moves along the guide shaft 92 in the main scanning direction A. The above structure can be modified such that the carriage 91 can move in the main scanning direction A in the frame 16 by another well-known moving mechanism.

As illustrated in FIGS. 3 and 4, the cleaning bath 40 may include an internal bath 42 which is mounted with an ultrasonic generating device 41, and an external bath 43 which supports the internal bath 42 and is coupled to the carriage 91. The external bath 43 may be provided with an inflow port 44 through which the cleaning liquid which may overflow the internal bath 42 flows into the external bath 43. The internal bath 42 is connected with the third connecting tube 23 which is also connected to the auxiliary tank 60, and the external bath 43 is connected with the fourth connecting tube 24 which is also connected to the pump 50. When the pump 50 operates, the cleaning liquid is supplied into the internal bath 42 through the third connecting tube 23. The cleaning liquid which overflows the internal bath 42 and flows into the external bath 43 flows to the pump 50 through the fourth connecting tube 24, and then is collected into the cleaning liquid tank 30 through the fifth connecting tube 25 which connects the pump 50 to the cleaning liquid tank 30.

If the proper amount, that is, a predetermined adequate amount, of cleaning liquid is supplied into the internal bath 42, the operation of the pump 50 is stopped, and the control device 13 controls the carriage 91 to move the cleaning bath 40 along the nozzle part 12 of the print head 11 to clean a different portion of the nozzle part 12. As illustrated in FIG. 3, during the cleaning operation of the nozzle part 12, the ultrasonic generating device 41 operates to generate an ultrasonic wave in an upward direction toward the nozzle part 12, and the cleaning liquid in the internal bath 42 moves toward the nozzle part 12 to clean away ink or the foreign substances which may be attached to the nozzle part 12. Because the cleaning bath 40 moves in the main scanning direction A along the frame 16 to clean the nozzle part 12 as described above, at least the third and fourth connecting tubes 23 and 24, which are connected to the cleaning bath 40, of the plural connecting tubes 21, 22, 23, 24 and 25, are each configured as a flexible tube. If the cleaning of the nozzle part 12 is completed, the control device 13 causes the operation of the ultrasonic generating device 41 to stop, and the pump 50 rotates in a reverse direction, so that the cleaning liquid in the internal bath 42 flows reversely to be collected into the cleaning liquid tank 30.

In such a process of cleaning the print head 11, if the ultrasonic generating device 41 is controlled to operate in a state such that the proper amount of cleaning liquid is not supplied into the internal bath 42, the ultrasonic generating device 41 may break down, or a problem in safety may occur. Further, if the cleaning liquid having an increased contamination level is reused, the cleaning efficiency of the cleaning operation is considerably decreased. Therefore, before the ultrasonic generating device 41 operates, the control device 13 may perform a check of the supply condition of the cleaning liquid to determine a contamination level of the cleaning liquid, which can be achieved by use of the sensing tube 70 and the sensor 80.

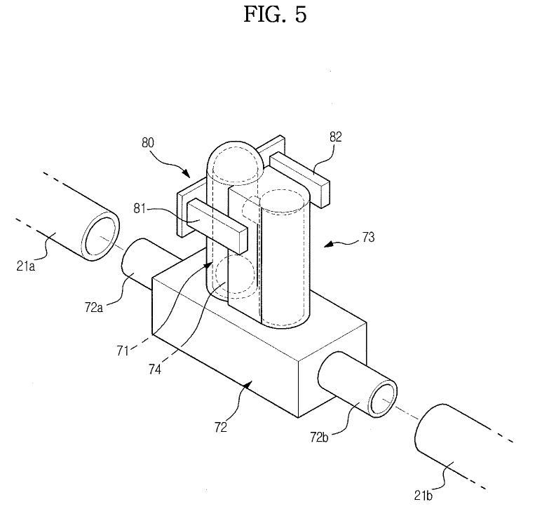

As illustrated in FIG. 4, the sensing tube 70 is mounted in a portion of the first connecting tube 21 through which the cleaning liquid discharged from the cleaning liquid tank 30 by the operation of the pump 50 flows into the pump 50. As illustrated in FIG. 5, the sensing tube 70 may include a flow passage 71 through which the cleaning liquid flows, a tube coupling part 72 provided in a portion, for example, a middle portion, of the first connecting tube 21, and a sensing part 73 protruding upward from the tube coupling part 72 substantially perpendicularly to the tube coupling part 72. The tube coupling part 72 may include a first coupling part 72a and a second coupling part 72b, each of which are coupled with the first connecting tube 21 such that the first coupling part 72a is coupled with a first portion 21a of the first connecting tube 21 which is connected to the cleaning liquid tank 30, and the second coupling part 72b is coupled with a second portion 21b of the first connecting tube 21 which is connected to the pump 50. The sensing part 73 may be made of a transparent material so that light can permeate so that a color level of cleaning fluid within the sensing part 73 which has flowed from the tube coupling part 72 and/or the flow passage 71 to the sensing part 73 may be more easily discerned by a user.

In other embodiments, the sensing tube 70, or another sensing tube 70, may be mounted in the second connecting tube 22 or the third connecting tube 23.

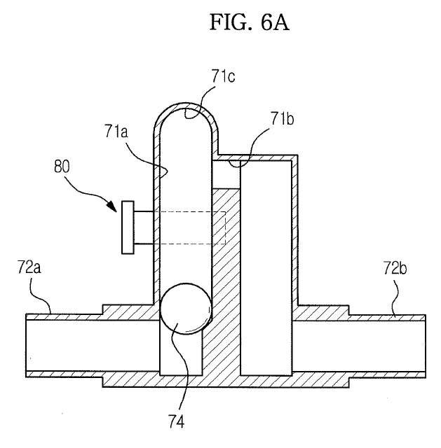

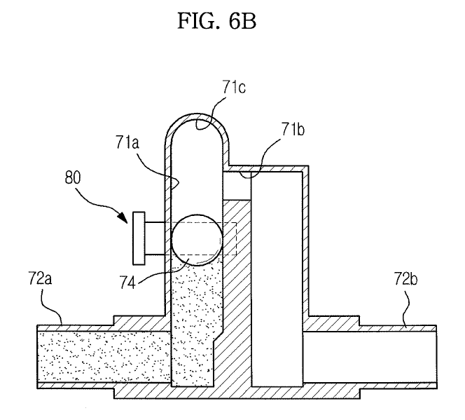

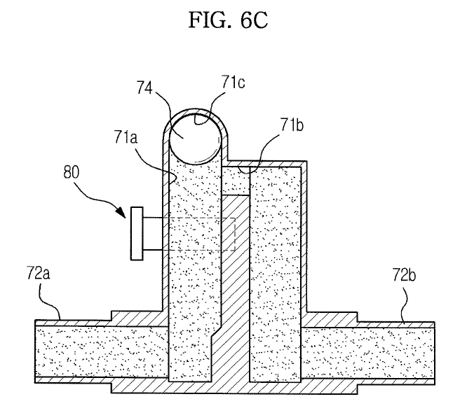

As illustrated in FIGS. 5 and 6A, the flow passage 71 of the sensing tube 70 may accommodate a moving member 74, which is described below in more detail. The moving member 74 is free to move up and down within a predetermined range within a movement guide portion 71a of the flow passage 71 by the flow of the cleaning liquid which flows into the flow passage 71. When the cleaning liquid supplied from the cleaning liquid tank 30 flows through the sensing tube 70 and into the flow passage 71, the moving member 74 moves up within the movement guide portion 71a by the pressure of the flowing cleaning liquid. When the cleaning liquid flows out of the flow passage 71, the moving member 74 moves down within the movement guide portion 71a by its own weight. The moving member 74 may be formed having a spherical shape having a diameter smaller than a width of the movement guide portion 71a, and may be filled with air or made of a light material so as to float freely on the cleaning liquid.

As illustrated in FIG. 5, a sensor 80 may be mounted to the exterior of a sensing part 73. The sensor 80 may be configured as an optical sensor which has a light emitting part 81 and a light receiving part 82. The sensing part 73, the light emitting part 81 and the light receiving part 82 are described below in further detail.

It is illustrated in FIG. 6A that the movement guide portion 71a extends vertically, however in another embodiment, the movement guide portion 71a may be slantedly provided within the sensing tube 70 so that the moving member 74 can move down by its own weight when the cleaning liquid flows out of the flow passage 71.

Referring to FIG. 6A, a connecting portion 71b is provided at an upper portion of the movement guide portion 71a to connect the movement guide portion 71a to the second coupling part 72b. The connecting portion 71b may have a width smaller than the diameter of the moving member 74 so that the moving member 74 cannot escape from the movement guide portion 71a. A shelter portion 71c may be provided at an upper end portion of the movement guide portion 71a, in which the moving member 74 can escape so as not to obstruct the flow of the cleaning liquid through the connecting portion 71b. When the cleaning liquid passes through the flow passage 71 of the sensing tube 70, the cleaning liquid flows into the second coupling part 72b via the first coupling part 72a, the movement guide portion 71a and the connecting portion 71b. Since the moving member 74 floats on the cleaning liquid, the moving member 74 remains in the shelter portion 71c positioned above the connecting portion 71b while the cleaning liquid is flowing from the first coupling part 72a to the second coupling part 72b. Accordingly, the moving member 74 does not obstruct the flow of the cleaning liquid through the flow passage 71.

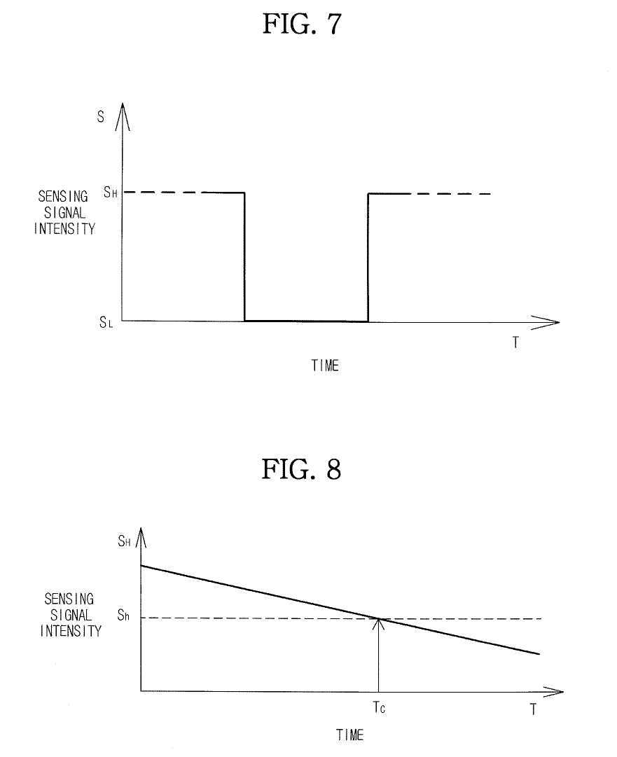

As described above, the sensor 80 may be mounted to the exterior of the sensing part 73. The sensor 80 may be configured as an optical sensor which has a light emitting part 81 and a light receiving part 82. The light emitting part 81 and the light receiving part 82 may be mounted within the sensor 80 such that the movement guide portion 71a is positioned therebetween. When the sensor 80 operates, the light generated from the light emitting part 81 permeates the transparent sensing part 73, and is transmitted to the light receiving part 82 which provides an electrical sensing signal (referring to FIG. 7) to the control device 13. The sensing signal provides information of the opacity of the cleaning fluid, and is described below in greater detail.

In this case, if the cleaning liquid does not flow in the movement guide portion 71a, or if the cleaning liquid which flows in the movement guide portion 71a is clear and has low opaqueness (that is, the clean fluid is clean), then much of the light emitted from the light emitting part 81 is received by the light receiving part 82. Therefore, the intensity of the sensing signal provided from the sensor 80 illustrates a high value SH (referring to FIG. 7). However, as illustrated in FIG. 6B, if the opaque moving member 74 is located between the light emitting part 81 and the light receiving part 82, the light emitted from the light emitting part 81 is mostly blocked, and cannot be received by the light receiving part 82. In this case, the intensity of the sensing signal generated from the sensor 80 indicates a low value SL.

Based upon the above principle, when the moving member 74 which is initially located on the bottom of the movement guide portion 71a (see FIG. 6A) moves up into the shelter portion 71c by the pressure of the supplied cleaning liquid (see FIG. 6C), the intensity of the sensing signal provided by the sensor 80 drops from the high value SH to the low value SL (as the moving member 74 moves between the light emitting part 81 and the light receiving part 82), and then rises again to the high value SH (as the moving member 74 moves away from the sensor 80), as illustrated in FIG. 7. Such a change of the intensity of the sensing signal is performed twice, that is, when the cleaning liquid is supplied into the cleaning bath 40, and when the cleaning liquid is collected into the cleaning liquid tank 30. In other words, when the pump 50 rotates in the forward direction and the cleaning liquid in the cleaning liquid tank 30 is supplied into the cleaning bath 40, the moving member 74 moves up by the supplied cleaning liquid, and passes between the light emitting part 81 and the light receiving part 82 for the first time. When the cleaning operation is terminated, if the pump 50 rotates in the reverse direction and the cleaning liquid in the cleaning bath 40 is collected and flows out of the sensing tube 70, the moving member 74 moves down by its own weight, and passes between the light emitting part 81 and the light receiving part 82 for the second time.

In other embodiments, instead of the optical sensor, other types of sensors capable of sensing the movement of the moving member 74 can be used as the sensor 80 of this embodiment. For example, an ultrasonic sensor can be used as the sensor 80. In this embodiment, the contamination level of the cleaning liquid can be detected by the transmittance of the ultrasonic wave, based upon a principle that as the concentration of the foreign substance contained in the cleaning liquid increases, the transmittance of the ultrasonic wave decreases.

In the process of cleaning the nozzle part 12, the control device 13 controls the pump 50 to rotate in the forward direction. If the intensity of the sensing signal drops from the high value SH to the low value SL and then rises again to the high value SH, the control device 13 determines that the cleaning liquid is smoothly supplied into the cleaning bath 40, and controls the pump 50 to rotate in the forward direction for a predetermined time, so that the internal bath 42 is filled with the cleaning liquid. When the cleaning operation for the nozzle part 12 is terminated, the control device 13 controls the pump 50 to rotate in the reverse direction. If the intensity of the sensing signal is changed once again, the control device 13 determines that all the cleaning liquid in the cleaning bath 40 has been collected, and controls the pump 50 to stop its operation.

The sensor 80 senses the contamination level of the cleaning liquid passing through the sensing tube 70 as well as the moving member 74 which moves up and down in the sensing tube 70. If the cleaning liquid is continuously reused, the cleaning liquid becomes more and more contaminated with the removed ink or foreign substances from the nozzle part 12. As the contamination level of the cleaning liquid increases, the intensity of the light incident and received by the light receiving part 82 of the sensor 80 decreases, and accordingly the intensity of the sensing signal generated from the sensor 80 also decreases.

As illustrated in a graph of FIG. 8, as time passes during operation of the print head cleaning device 20, the maximum intensity of the sensing signal provided by the sensor 80 gradually decreases. If the measured high value SH of the sensing signal drops below a predetermined limit signal value Sh, the control device 13 does not perform the cleaning operation, and indicates through the display device 15 that the contamination level of the cleaning liquid is high and needs to be replaced. A time TC, when the maximum high value SH of the sensing signal drops below the predetermined limit signal value Sh, is a replacing time of the cleaning liquid, and thereby enables a user to easily determine when to replace the cleaning liquid.

Hereinafter, an operation of the ink-jet image forming apparatus and the print head cleaning device according to the present general inventive concept will be described with reference to FIGS. 1-6.

When the amount of contamination of the nozzle part 12 of the print head 11 is great, the operation of cleaning the nozzle part 12 is carried on by a user's command inputted through the manipulation part 14 to the control device 13, or is automatically carried on by the control device 13 without a user input.

The control device 13 controls the pump 50 to rotate in the forward direction so that the cleaning liquid in the cleaning liquid tank 30 flows toward the cleaning bath 40, and operates the sensor 80. When the sensor 80 operates initially, the intensity of the sensing signal provided by the sensor 80 indicates a high value SH. If the cleaning liquid supplied from the cleaning liquid tank 30 through the first connecting tube 21 flows into the movement guide portion 71a of the sensing tube 70, the moving member 74 in the movement guide portion 71a passes between the light emitting part 81 and the light receiving part 82 by the pressure of the flowing cleaning liquid, and reaches the shelter portion 71c. At this case, the intensity of the sensing signal provided by the sensor 80 drops from the high value SH to the low value SL, and then rises again to the high value SH.

When the intensity of the sensing signal is changed while the pump 50 rotates in the forward direction, the control device 13 determines that the amount of cleaning liquid stored in the cleaning liquid tank 30 is sufficient, and determines whether the high value SH, to which the intensity of the sensing signal again rises after dropping to the low value SL, is larger than the limit signal value Sh. If the high value SH of the intensity of the sensing signal is larger than the limit signal value Sh, the control device 13 controls the pump 50 to continuously rotate in the forward direction so that the internal bath 42 is filled with the cleaning liquid. Subsequently, the control device 13 determines whether the supply of the cleaning liquid into the cleaning bath 40 is completed. If the control device 13 determines that the supply of the cleaning liquid into the cleaning bath 40 is completed, the control device 13 stops the operation of the pump 50, operates the driving motor 94 to move the carriage 91 loaded with the cleaning bath 40 in the main scanning direction A, and operates the ultrasonic generating device 41. The supply of the cleaning liquid into the internal bath 42 can be controlled by controlling an operating time, or a number of rotations, of the pump 50, or can be controlled by installing a sensor (not illustrated) capable of sensing the cleaning liquid supplied to the cleaning bath 40.

When the ultrasonic generating device 41 operates, the cleaning liquid supplied into the cleaning bath 40 moves upward toward the nozzle part 12 of the print head 11, and cleans the nozzle part 12. While such a cleaning operation is performed along the nozzle part 12 formed lengthwise in the main scanning direction A, the control device 13 determines whether the cleaning operation for the entire nozzle part 12 is completed. If the control device 13 determines that the cleaning operation is completed, the control device 13 controls the pump 50 to rotate in the reverse direction to collect the cleaning liquid from the cleaning bath 40. In this case, the control device 13 can determine whether the cleaning operation is completed, by sensing the position of the carriage 91 or the cleaning bath 40 along the frame 16.

When the pump 50 rotates in the reverse direction, the cleaning liquid in the cleaning bath 40 flows in the direction opposite to the supply direction, and is collected into the cleaning liquid tank 30. While the cleaning liquid is collected, the control device 13 determines whether the intensity of the sensing signal provided by the sensor 80 is changed. When the cleaning liquid is collected into the cleaning liquid tank 30 from the cleaning bath 40 as well as the connecting tubes 21, 22 and 23 connecting the cleaning bath 40 and the cleaning liquid tank 30, if the cleaning liquid flows out of the sensing tube 70, the moving member 74 located at the shelter portion 71c moves down to the bottom of the movement guide portion 71a by its own weight. When the moving member 74 passes between the light emitting part 81 and the light receiving part 82, the intensity of the sensing signal generated from the sensor 80 is changed. At this time, the control device 13 stops the operation of the pump 50.

After controlling the pump 50 to rotate in the forward direction to supply the cleaning liquid into the cleaning bath 40, if the intensity of the sensing signal is not changed, the control device 13 determines that the cleaning liquid tank 30 lacks an adequate amount of cleaning liquid, or determines that the cleaning liquid cannot be supplied normally because the flow passage is blocked. Then, the control device 13 stops the operation of the pump 50, and indicates an error message through the display device 15. Accordingly, the cleaning process is controlled by the control device 13 such that the ultrasonic generating device 41 is not allowed to operate in a state where the cleaning bath 40 is not adequately supplied with cleaning liquid.

Although the intensity of the sensing signal is changed after controlling the pump 50 to rotate in the forward direction, if the maximum measured high value SH of the intensity of the sensing signal is smaller than the limit signal value Sh, the control device 13 determines that the cleaning liquid has a high contamination level and is inadequate for the cleaning operation, and indicates this information through the display device 15.

In the above description, the ink-jet image forming apparatus equipped with the array type print head has been exemplified as the present general inventive concept, however the present general inventive concept can also be applied to an ink-jet image forming apparatus equipped with a shuttle type print head.

As apparent from the above description, the ink-jet image forming apparatus according to the present general inventive concept can ascertain whether the cleaning liquid in the cleaning liquid tank is smoothly supplied into the cleaning bath, because the sensing tube provided with the moving member which moves up and down by the flow of the cleaning liquid is mounted within the connecting tube which connects the cleaning liquid tank to the cleaning bath having the ultrasonic generating device, and the movement of the moving member within the sensing tube is sensed by the sensor. Accordingly, the ultrasonic generating device can be prevented from operating in a state that the cleaning bath lacks an adequate amount of cleaning liquid. As a result, safety of use is enhanced.

Further, since the contamination level of the cleaning liquid is sensed by the sensor, a user can easily determine when to replace the cleaning liquid.

Although a few embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An ink-jet image forming apparatus, comprising:
a print head having a nozzle part to eject an ink; and
a print head cleaning device to clean the nozzle part, the print head cleaning device including:
a cleaning liquid tank to store a cleaning liquid;
a cleaning bath mounted below the nozzle part to be supplied with the cleaning liquid from the cleaning liquid tank;
a connecting tube to connect the cleaning liquid tank to the cleaning bath;
a pump connected to the connecting tube to circulate the cleaning liquid;
a sensing tube mounted in a portion of the connecting tube and provided with a flow passage through which the cleaning liquid flows;
a moving member mounted within the flow passage of the sensing tube so as to freely move by the flow of the cleaning liquid; and
a sensor to sense the movement of the moving member.

2. The ink-jet image forming apparatus according to claim 1, wherein the sensing tube further comprises:
a movement guide portion disposed within the flow passage, in which the moving member moves up by the flowing cleaning liquid and moves down by its own weight.

3. The ink-jet image forming apparatus according to claim 2, wherein the sensing tube further comprises:
a connecting portion disposed within the flow passage, which connects the movement guide portion to a portion of the connecting tube disposed in close proximity to the cleaning bath, and the movement guide portion is provided with a shelter portion which is formed above the connecting portion,
whereby when the cleaning liquid flows, the moving member escapes into the shelter portion without blocking the flow of the cleaning liquid in the connecting portion.

4. The ink-jet image forming apparatus according to claim 3, wherein the moving member floats on the cleaning liquid.

5. The ink-jet image forming apparatus according to claim 1, wherein the sensing tube is transparent, and the sensor is configured as an optical sensor having a light emitting part and a light receiving part, the light emitting part and the light receiving part being arranged such that the flow passage of the sensing tube is interposed therebetween.

6. The ink-jet image forming apparatus according to claim 5, wherein the sensor is capable of sensing a contamination level of the cleaning liquid flowing through the sensing tube.

7. The ink-jet image forming apparatus according to claim 1, further comprising:
a control device to control an operation of the pump in response to a sensing signal provided by the sensor.

8. A print head cleaning device, comprising:
a cleaning liquid tank to store a cleaning liquid;
a cleaning bath supplied with the cleaning liquid from the cleaning liquid tank;
a connecting tube to connect the cleaning liquid tank to the cleaning bath;
a pump connected to the connecting tube to circulate the cleaning liquid;
a sensing tube mounted in a portion of the connecting tube and provided with a flow passage through which the cleaning liquid flows;
a moving member mounted within the flow passage of the sensing tube so as to move by the flow of the cleaning liquid; and
a sensor to sense the movement of the moving member.

9. The print head cleaning device according to claim 8, wherein the sensing tube is provided with a movement guide portion in the flow passage, in which the moving member moves up by the flowing cleaning liquid and moves down by its own weight.

10. The print head cleaning device according to claim 9, wherein the sensing tube is provided with a connecting portion in the flow passage, which connects the movement guide portion and a portion of the connecting tube disposed in close proximity to the cleaning bath, and the movement guide portion is provided with a shelter portion which is formed above the connecting portion,
whereby when the cleaning liquid flows, the moving member escapes into the shelter portion without blocking the flow of cleaning fluid in the connecting portion.

11. The print head cleaning device according to claim 10, wherein the moving member floats on the cleaning liquid.

12. The print head cleaning device according to claim 8, wherein the sensing tube is transparent, and the sensor is configured as an optical sensor having a light emitting part and a light receiving part, the light emitting part and the light receiving part being arranged such that the flow passage of the sensing tube is interposed therebetween.

13. The print head cleaning device according to claim 12, wherein the sensor is capable of sensing a contamination level of the cleaning liquid flowing through the sensing tube.

14. A print head cleaning device, comprising:
a cleaning liquid tank to store a cleaning liquid;
a cleaning bath to clean the print head;
a pump to circulate the cleaning liquid between the cleaning liquid tank and the cleaning bath; and
a connecting tube to connect the cleaning liquid tank, the pump and the cleaning bath to flow the cleaning liquid therein, the connecting tube including a sensing unit mounted therein to sense the opacity of the cleaning liquid in the connecting tube.

15. The print head cleaning device of claim 14, wherein the sensing unit comprises:
a tube coupling part to connect to the connecting tube; and
a flow passage connected to the tube coupling part and having a sensor disposed thereon to sense the opacity of the cleaning liquid flowing within the flow passage.

16. The print head cleaning device of claim 14, wherein a circulation operation of the pump ceases when the sensed opacity of the cleaning liquid is greater than a predetermined level.

17. A method to control a cleaning operation of a print head, the method comprising:
operating a pump to cause the cleaning fluid to flow in a first direction between a cleaning liquid tank and a cleaning bath;
sensing a level change of a sensing signal provided by a sensor which senses a position of a moving member in the flow of the cleaning fluid;
determining whether an adequate amount of cleaning fluid is present in the cleaning bath according to the sensed level change of the sensing signal;
stopping the pump when the adequate amount of cleaning fluid is present; and
operating an ultrasonic generating device to clean a plurality of nozzles disposed on the print head.

18. The method of claim 17, further comprising:
operating the pump to cause the cleaning fluid to flow in a second direction between the cleaning liquid tank and the cleaning bath.

19. The method of claim 17, further comprising:
stopping the pump operation when an inadequate amount of cleaning fluid is sensed according to the sensing of the level change of the sensing signal.

20. The method of claim 17, further comprising:
sensing a contamination level of the cleaning fluid flowing between a cleaning liquid tank and a cleaning bath.

21. The method of claim 20, further comprising:
providing an error message to a display when the sensed contamination level is greater than a predetermined level.
